(19) United States
(12) Patent Application Publication
(10) Pub. No.: US 2025/0193960 A1
(43) Pub. Date: Jun. 12, 2025

(54) METHODS AND APPARATUSES FOR MOBILITY IN MULTIPLE TRPS WITH MULTIPLE TA

(71) Applicant: LENOVO (BEIJING) LIMITED, Beijing (CN)

(72) Inventors: Lianhai Wu, Beijing (CN); Ran Yue, Beijing (CN); Jing Han, Beijing (CN); Haiming Wang, Beijing (CN); Min Xu, Beijing (CN)

(21) Appl. No.: 18/859,590

(22) PCT Filed: Apr. 25, 2022
(86) PCT No.: PCT/CN2022/088991

§ 371 Date: Oct. 24, 2024

(51) Int. Cl. H04W 76/20; H04W 56/00; H04W 74/0833; H04W 76/18

(52) U.S. Cl. CPC H04W 76/20; H04W 56/0045; H04W 74/0833; H04W 76/18

(57) ABSTRACT

Embodiments of the present application relate to methods and apparatuses for mobility in a case of multiple transmission reception points (TRPs) with multiple timing advance (TA). According to an embodiment of the present application, a user equipment (UE) includes a transceiver and a processor coupled to the transceiver, wherein the processor is configured: to receive a radio resource control (RRC) reconfiguration message for mobility associated with a target cell via the transceiver from a network, wherein the RRC reconfiguration message for mobility includes a configuration regarding two transmission reception points (TRPs) of the target cell, and wherein the two TRPs have two different timing advance (TA), respectively; and in response to receiving the RRC reconfiguration message for mobility, to perform a random access (RA) procedure to the target cell and to start a mobility timer.

### TECHNICAL FIELD

Embodiments of the present application generally relate to wireless communication technology, especially to methods and apparatuses for mobility in a case of multiple transmission reception points (TRPs) with multiple timing advance (TA).

### BACKGROUND

Next generation radio access network (NG-RAN) supports a multi-radio dual connectivity (MR-DC) operation. In the MR-DC operation, a user equipment (UE) with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3GPP standard documents), and at least the MN is connected to the core network. Different from MR-DC, a standalone (SA) scenario refers to a case which is not configured with a dual connectivity (DC) operation, and may also be named as “a non-MR-DC case” or the like.

Currently, multiple TRPs with one single TA are supported in 3rd Generation Partnership Project (3GPP) standard documents. Multiple TAs for multiple TRPs operation will be supported in 3GPP Rel-18. In some cases, multiple TRPs may also be named as “mTRP” or “multi TRPs” or “multi-TRP” or the like. However, several issues related to mobility in a MR-DC case or a SA case of multiple TRPs with multiple TA have not been discussed yet and the corresponding solutions have not been specified.

### SUMMARY

Some embodiments of the present application provide a user equipment (UE). The UE includes a transceiver and a processor coupled to the transceiver, wherein the processor is configured: to receive a radio resource control (RRC) reconfiguration message for mobility associated with a target cell via the transceiver from a network, wherein the RRC reconfiguration message for mobility includes a configuration regarding two transmission reception points (TRPs) of the target cell, and wherein the two TRPs have two different timing advance (TA), respectively; and in response to receiving the RRC reconfiguration message for mobility, to perform a random access (RA) procedure to the target cell and to start a mobility timer.

In some embodiments, the target cell is a primary cell of a master cell group (PCell) or a primary cell of a second cell group (PSCell).

In some embodiments, the configuration indicates that the two TRPs are belonging to different timing advance groups (TAGs).

In some embodiments, the configuration includes first identity (ID) information of each TRP within the two TRPs.

In some embodiments, the RRC reconfiguration message for mobility indicates a first TRP or a primary TRP to which the UE can perform the RA procedure within the two TRPs.

In some embodiments, the processor of the UE is configured to perform the RA procedure to the first TRP or the primary TRP.

In some embodiments, the processor of the UE is configured: to stop the mobility timer upon a successful completion of the RA procedure to the first TRP or the primary TRP; and to transmit an RRC reconfiguration complete message via the transceiver to the target cell.

In some embodiments, the processor of the UE is configured: to stop the mobility timer upon a successful completion of the RA procedure to one TRP within the two TRPs; and to transmit an RRC reconfiguration complete message via the transceiver to the target cell.

In some embodiments, in response to failing to complete the RA procedure to one TRP within the two TRPs, the processor of the UE is configured to transmit failure information regarding the one TRP via the transceiver to the network.

In some embodiments, the failure information is transmitted via an RRC reconfiguration complete message or other RRC message.

In some embodiments, the failure information includes at least one of: second ID information of the one TRP in which a RA failure happens, or a failure cause.

In some embodiments, the failure cause includes at least one of: reaching a maximum number of preamble transmission of the one TRP; or an occurrence of the RA failure.

In some embodiments, the processor of the UE is configured to perform the RA procedure to a second TRP within the two TRPs upon: the successful completion of the RA procedure to the other TRP within the two TRPs; an uplink (UL) data arrival associated with the second TRP; or a reception of a message for requesting the UE to perform the RA procedure to the second TRP via the transceiver from the network.

In some embodiments, the processor of the UE is configured: to stop the mobility timer upon a successful completion of the RA procedure to all of the two TRPs; and to transmit an RRC reconfiguration complete message via the transceiver to the target cell.

In some embodiments, in response to failing to complete the RA procedure to all of the two TRPs upon an expiry of the mobility timer, the processor of the UE is configured to perform an RRC re-establishment procedure to a first cell, and wherein the first cell is different from or identical with the target cell.

In some embodiments, in response to an occurrence of a handover failure, the processor of the UE is configured to transmit at least one of a radio link failure (RLF) report or a re-establishment request message via the transceiver to the first cell.

In some embodiments, the at least one of the RLF report or the re-establishment request message includes at least one of: third ID information of each TRP to which the RA procedure is successfully completed within the two TRPs; or fourth ID information of each TRP to which the RA procedure is failed within the two TRPs.

In some embodiments, at least one of the first ID information, the second ID information, the third ID information, or the fourth ID information includes at least one of: a control resource set (CORESET) ID; a panel ID; or a beam set ID.

Some embodiments of the present application provide a method performed by a UE. The method includes: receiving a radio resource control (RRC) reconfiguration message for mobility associated with a target cell from a network, wherein the RRC reconfiguration message for mobility includes a configuration regarding two transmission reception points (TRPs) of the target cell, and wherein the two TRPs have two different timing advance (TA), respectively; and in response to receiving the RRC reconfiguration message for mobility, performing a random access (RA) procedure to the target cell and starting a mobility timer.

Some embodiments of the present application provide a network node (e.g., a base station (BS)). The network node includes a transceiver and a processor coupled to the transceiver, wherein the processor is configured: to transmit a radio resource control (RRC) reconfiguration message for mobility associated with a target cell via the transceiver to a user equipment (UE), wherein the RRC reconfiguration message for mobility includes a configuration regarding two transmission reception points (TRPs) of the target cell, and wherein the two TRPs have two different timing advance (TA), respectively.

In some embodiments, the target cell is a primary cell of a master cell group (PCell) or a primary cell of a second cell group (PSCell).

In some embodiments, the configuration indicates that the two TRPs are belonging to different timing advance groups (TAGs).

In some embodiments, the configuration includes first identity (ID) information of each TRP within the two TRPs.

In some embodiments, the RRC reconfiguration message for mobility indicates a first TRP or a primary TRP to which the UE can perform the RA procedure within the two TRPs.

In some embodiments, the processor of the network node is configured to receive an RRC reconfiguration complete message via the transceiver from the UE, in response to a successful completion of the RA procedure to the first TRP or the primary TRP.

In some embodiments, the processor of the network node is configured to receive an RRC reconfiguration complete message via the transceiver from the UE, in response to a successful completion of the RA procedure to one TRP within the two TRPs.

In some embodiments, in response to failing to complete the RA procedure to one TRP within the two TRPs, the processor of the network node is configured to receive failure information regarding the one TRP via the transceiver from the UE.

In some embodiments, the failure information is received via an RRC reconfiguration complete message or other RRC message.

In some embodiments, the failure information includes at least one of: second ID information of the one TRP in which a RA failure happens, or a failure cause.

In some embodiments, the failure cause includes at least one of: reaching a maximum number of preamble transmission of the one TRP; or an occurrence of the RA failure.

In some embodiments, the processor of the network node is configured to transmit a message for requesting the UE to perform the RA procedure to a TRP within the two TRPs via the transceiver to the UE.

In some embodiments, the RA procedure to a second TRP within the two TRPs is performed by the UE upon: the successful completion of the RA procedure to the other TRP within the two TRPs; an uplink (UL) data arrival associated with the second TRP; or a reception of a message for requesting the UE to perform the RA procedure to the second TRP via the transceiver from the network.

In some embodiments, the processor of the network node is configured to receive an RRC reconfiguration complete message via the transceiver from the UE, in response to a successful completion of the RA procedure to all of the two TRPs.

In some embodiments, the processor of the network node is configured to receive at least one of a radio link failure (RLF) report or a re-establishment request message via the transceiver from the UE, in response to at least one of: the UE failing to complete the RA procedure to all of the two TRPs upon an expiry of the mobility timer; the UE performing an RRC re-establishment procedure to the target cell; or an occurrence of a handover failure.

In some embodiments, the at least one of the RLF report or the re-establishment request message includes at least one of: third ID information of each TRP to which the RA procedure is successfully completed within the two TRPs; or fourth ID information of each TRP to which the RA procedure is failed within the two TRPs.

In some embodiments, at least one of the first ID information, the second ID information, the third ID information, or the fourth ID information includes at least one of: a control resource set (CORESET) ID; a panel ID; or a beam set ID.

Some embodiments of the present application provide a method performed by network node (e.g., a BS). The method includes: transmitting a radio resource control (RRC) reconfiguration message for mobility associated with a target cell to a user equipment (UE), wherein the RRC reconfiguration message for mobility includes a configuration regarding two transmission reception points (TRPs) of the target cell, and wherein the two TRPs have two different timing advance (TA), respectively.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary communication system of multiple TRPs according to some embodiments of the present application.

FIG. 2 illustrates an exemplary flowchart of receiving an RRC reconfiguration message for mobility according to some embodiments of the present application.

FIG. 3 illustrates an exemplary flowchart of a PCell change procedure according to some embodiments of the present application.

FIG. 4 illustrates a further exemplary flowchart of a PCell change procedure according to some embodiments of the present application.

FIG. 5 illustrates an exemplary flowchart of a SCG addition procedure according to some embodiments of the present application.

FIG. 6 illustrates an exemplary block diagram of an apparatus 600 for a case of multiple TRPs with multiple TA according to some embodiments of the present application.

FIG. 7 illustrates a further exemplary block diagram of an apparatus 700 for a case of multiple TRPs with multiple TA according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

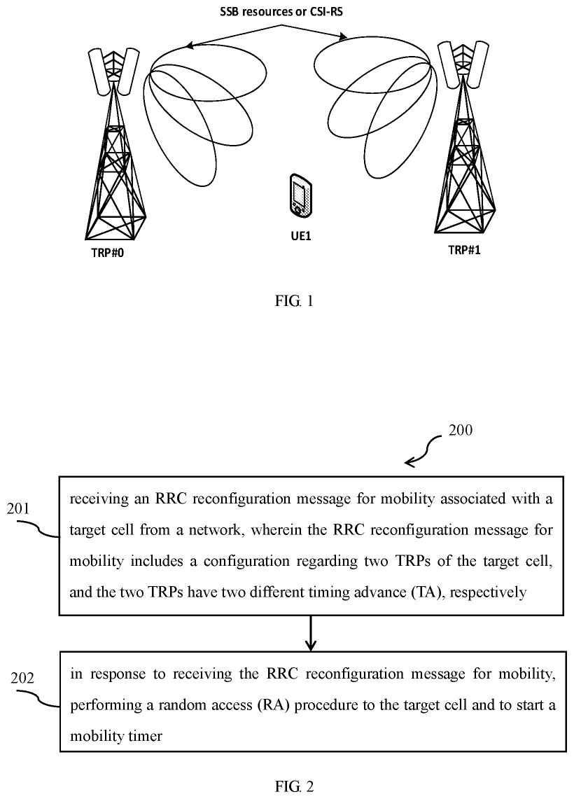

FIG. 1 illustrates an exemplary communication system of multiple TRPs according to some embodiments of the present application.

In some cases, UE1 may receive, from a serving cell, configuration(s) of SSB(s) or a CSI-RS of a TRP (e.g., TRP #0 and/or TRP #1) with a PCID for a beam measurement and resource configuration(s) for data transmission or data reception associated with the PCID. UE1 performs a beam measurement for the TRP with the PCID and reports a measurement result to the serving cell. Based on the above reports, TCI state(s) associated with the TRP with the PCID is activated from the serving cell (by L1 signaling or L2 signaling). A TCI may be a SSB or a CSI-RS. UE1 receives and transmits using a UE-dedicated channel on the TRP with the PCID. UE1 should be in coverage of a serving cell always, also for a multi-TRP case, e.g., UE1 should use BCCH, PCCH, etc., from the serving cell. As shown in FIG. 1, UE1 is served by TRP #0 and TRP #1. UE1 can receive data from TRP #0 and TRP #1 at the same time.

In some embodiments of the present application, UE1 as shown in FIG. 1 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, networks (e.g., TRPs, routers, switches, and modems), or the like. In some other embodiments of the present application, UE1 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE1 may include wearable devices, such as smart watches, fitness bands, optical head-mounted displays, or the like. Moreover, UE1 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present application, UE1 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE1 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE1 may include wearable devices, such as smart watches, fitness bands, optical head-mounted displays, or the like. Moreover, UE1 may be referred to as a subscriber unit, a mobile, a mobile station, a user, a terminal, a mobile terminal, a wireless terminal, a fixed terminal, a subscriber station, a user terminal, or a device, or described using other terminology used in the art.

Currently, a scenario regarding multiple TRPs with different TA configured to a target PCell or a target PSCell has not been discussed yet and several issues need to be addressed. Embodiments of the subject application aim to solve issues that may be faced in a case of multiple TRPs with different TA configured to a target PCell or a target PSCell. Some embodiments of the subject application design a mechanism for multiple TRPs with different TA in the case of a handover procedure for MCG, a SCG addition procedure, or a SCG change procedure. Some embodiments of the subject application specify a mechanism for determining whether a procedure regarding multiple TRPs with different TA is successful or failed. Some embodiments of the subject application specify a UE's behaviours once a procedure regarding multiple TRPs with different TA is successful or failed.

More details regarding embodiments of the present application will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

FIG. 2 illustrates an exemplary flowchart of receiving an RRC reconfiguration message for mobility according to some embodiments of the present application. The exemplary method 200 in FIG. 2 may be performed by a UE (e.g., UE1 as shown in FIG. 1). Although described with respect to a UE, it should be understood that other devices may also be configured to perform the method as shown in FIG. 2.

In the exemplary method 200 as shown in FIG. 2, in operation 201, a UE (e.g., UE1 as shown in FIG. 1) receives an RRC reconfiguration message for mobility associated with a target cell from a network. The RRC reconfiguration message for mobility includes a configuration regarding two TRPs of the target cell. These two TRPs have two different TA, respectively. In operation 202, in response to receiving the RRC reconfiguration message for mobility, the UE performs a random access (RA) procedure to the target cell and starting a mobility timer (e.g., T304). The target cell may be a primary cell of a master cell group (PCell) or a primary cell of a second cell group (PSCell).

In some embodiments, the configuration indicates that these two TRPs are belonging to different timing advance groups (TAGs). In some embodiments, the configuration includes identity (ID) information of each TRP within these two TRPs. The ID information may be a control resource set (CORESET) ID; a panel ID; and/or a beam set ID.

In some embodiments, the RRC reconfiguration message for mobility indicates a TRP, to which the UE can perform the RA procedure, within these two TRPs. In an embodiment, the TRP could be a TRP (named as 1st TRP for simplicity) with the first entry in a TRP list included in an RRC message, e.g., the RRC reconfiguration message. In a further embodiment, the TRP may be a primary TRP within these two TRPs.

In some embodiments, the UE performs the RA procedure to the 1st TRP or the primary TRP. In an embodiment, the UE stops the mobility timer (e.g., T304) upon a successful completion of the RA procedure to the 1st TRP or the primary TRP, and transmits an RRC reconfiguration complete message to the target cell.

In some embodiments, the UE stops the mobility timer (e.g., T304) upon a successful completion of the RA procedure to one TRP within these two TRPs, and transmits an RRC reconfiguration complete message to the target cell.

In some embodiments, in response to failing to complete the RA procedure to one TRP within these two TRPs, the UE transmits failure information regarding the one TRP to the network. In an embodiment, the failure information is transmitted via an RRC reconfiguration complete message or other RRC message. In an embodiment, the failure information includes: ID information of the one TRP in which a RA failure happens, and/or a failure cause. The ID information of the one TRP may be a CORESET ID; a panel ID; and/or a beam set ID. The failure cause may include: reaching a maximum number of preamble transmission of the one TRP, and/or an occurrence of the RA failure.

In some embodiments, the UE performs the RA procedure to a further TRP within these two TRPs upon: the successful completion of the RA procedure to the other TRP within these two TRPs; or an uplink (UL) data arrival associated with the further TRP; or a reception of a message for requesting the UE to perform the RA procedure to the further TRP from the network.

In some embodiments, the UE stops the mobility timer (e.g. T304) upon a successful completion of the RA procedure to all of these two TRPs; and transmits an RRC reconfiguration complete message to the target cell.

In some embodiments, in response to failing to complete the RA procedure to all of these two TRPs upon an expiry of the mobility timer (e.g. T304), the UE performs an RRC re-establishment procedure to a cell which may be different from or identical with the target cell. In an embodiment, in response to an occurrence of a handover failure, the UE transmits a radio link failure (RLF) report and/or a re-establishment request message to this re-established cell.

In some embodiments, the RLF report and/or the re-establishment request message includes: ID information of each TRP to which the RA procedure is successfully completed within these two TRPs; and/or ID information of each TRP to which the RA procedure is failed within these two TRPs. The ID information of each TRP may be a CORESET ID; a panel ID; and/or a beam set ID.

It should be appreciated by persons skilled in the art that the sequence of the operations in exemplary procedure 200 may be changed and some of the operations in exemplary procedure 200 may be eliminated or modified, without departing from the spirit and scope of the disclosure. Details described in all other embodiments of the present application are applicable for the embodiments of FIG. 2. Moreover, details described in the embodiments of FIG. 2 are applicable for all the embodiments of FIGS. 1 and 3-7.

In addition, some embodiments of the present application provide an exemplary flowchart of a network node (e.g., a BS) transmitting an RRC reconfiguration message for mobility according to some embodiments of the present application. Although described with respect to a network node, it should be understood that other devices may be configured to perform a similar method.

It should be appreciated by persons skilled in the art that the sequence of the operations in this exemplary flowchart of a network node may be changed and some of the operations in this exemplary flowchart may be eliminated or modified, without departing from the spirit and scope of the disclosure. Details described in all other embodiments of the present application, e.g., in the embodiments of FIG. 2 are applicable for this exemplary flowchart. Moreover, details described in this exemplary flowchart are applicable for all the embodiments of FIGS. 1-7.

In particular, in this exemplary flowchart, a BS (e.g., BS 102 as shown in FIG. 1) transmits an RRC reconfiguration message for mobility associated with a target cell to a UE. The RRC reconfiguration message for mobility includes a configuration regarding two TRPs of the target cell. These two TRPs have two different TA, respectively. The target cell may be a PCell or a PSCell.

In some embodiments, the configuration indicates that these two TRPs are belonging to different TAGs. In some embodiments, the configuration includes ID information of each TRP within these two TRPs. The ID information may be a CORESET ID; a panel ID; and/or a beam set ID.

In some embodiments, the RRC reconfiguration message for mobility indicates a TRP to which the UE can perform the RA procedure within these two TRPs. In an embodiment, the TRP could be a TRP (named as 1st TRP for simplicity) with the first entry in a TRP list included in a configuration message, e.g., the RRC reconfiguration message. In a further embodiment, the TRP may be a primary TRP within these two TRPs.

In some embodiments, the network node receives an RRC reconfiguration complete message from the UE, in response to a successful completion of the RA procedure to the 1st TRP or the primary TRP.

In some embodiments, the network node receives an RRC reconfiguration complete message from the UE, in response to a successful completion of the RA procedure to one TRP within these two TRPs.

In some embodiments, in response to failing to complete the RA procedure to one TRP within these two TRPs, the network node receives failure information regarding the one TRP from the UE. In an embodiment, the failure information is received via an RRC reconfiguration complete message or other RRC message. The failure information includes: ID information of the one TRP in which a RA failure happens, and/or a failure cause. For example, the failure cause includes: reaching a maximum number of preamble transmission of the one TRP; and/or an occurrence of the RA failure.

In some embodiments, the network node transmits a message for requesting the UE to perform the RA procedure to a TRP within these two TRPs to the UE.

In some embodiments, the RA procedure to a further TRP within these two TRPs is performed by the UE upon: the successful completion of the RA procedure to the other TRP within these two TRPs; a UL data arrival associated with the further TRP; or a reception of a message for requesting the UE to perform the RA procedure to the further TRP from the network.

In some embodiments, the network node receives an RRC reconfiguration complete message from the UE, in response to a successful completion of the RA procedure to all of these two TRPs.

In some embodiments, the network node receives a RLF report and/or a re-establishment request message from the UE, in response to at least one of: the UE failing to complete the RA procedure to all of these two TRPs upon an expiry of the mobility timer; the UE performing an RRC re-establishment procedure to the target cell; or an occurrence of a handover failure.

In some embodiments, the RLF report and/or the re-establishment request message includes at least one of: ID information of each TRP to which the RA procedure is successfully completed within these two TRPs; or ID information of each TRP to which the RA procedure is failed within these two TRPs. The ID information of each TRP may include at least one of: a CORESET ID; a panel ID; or a beam set ID.

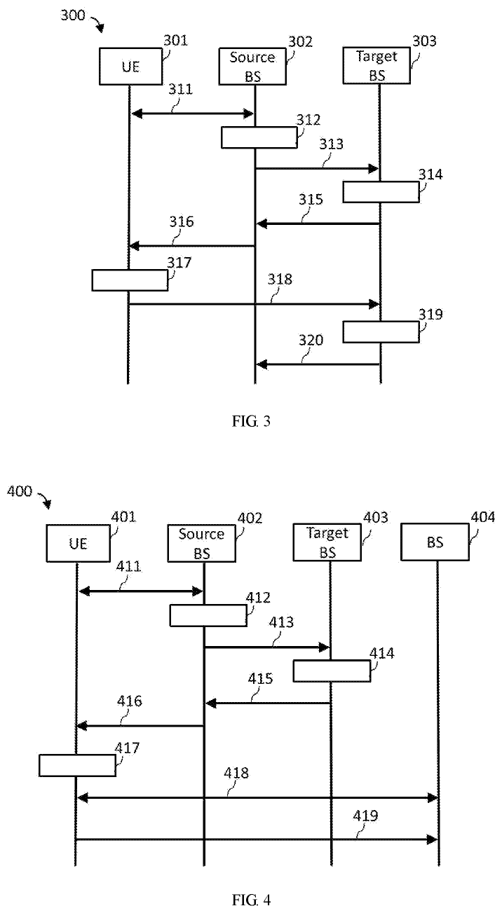

FIG. 3 illustrates an exemplary flowchart of a PCell change procedure according to some embodiments of the present application. Details described in all other embodiments of the present disclosure are applicable for the embodiments shown in FIG. 3. Referring to FIG. 3, UE 301 may function as UE1 as shown in FIG. 1. In particular, there may be following three specific embodiments in different cases in exemplary procedure 300, i.e., Embodiment #1, Embodiment #2, and Embodiment #3.

In Embodiment #1, exemplary procedure 300 includes following steps.
(1) Step 311: Source BS 302 transmits an RRC reconfiguration message including measurement configuration(s) to UE 301, and UE 301 transmits a measurement report according to the measurement configuration(s).
   1) UE 301 reports capability information to source BS 302, e.g., whether UE 301 supports multiple TRPs with different TA or not.
(2) Step 312: Source BS 302 decides to handover UE 301 based on the measurement report from UE 301.
(3) Step 313: Source BS 302 transmits a handover request message to target BS 303.
(4) Step 314: Target BS 303 performs an admission control based on the load and the service supported by target BS 303.
(5) Step 315: Target BS 303 sends a handover request acknowledge message to source BS 302, which includes a transparent container to be sent to UE 301 as an RRC message to perform the handover.
(6) Step 316: Source BS 302 sends an RRC reconfiguration message to UE 301 after source BS 302 receives the handover request acknowledge message.
   1) If multiple TRPs (e.g., two TRPs) having different TA are configured to a target PCell, the RRC reconfiguration message may further indicate to which TRP UE 301 can perform a random access (RA) during mobility.
      In one embodiment, it may be defined in 3GPP specification that UE 301 needs to perform a RA on a specific TRP, for example, the primary TRP or TRP #0. TRP #0 may be a TRP with the first entry in a TRP list configured in the RRC reconfiguration message. TRP #0 may be named as “first TRP” or the like.
(7) Step 317: UE 301 starts timer T304 and performs the RA to the specific TRP, which may be the primary TRP or TRP #0.
   1) In an embodiment, UE 301 stops T304 when UE 301 completes the RA in the primary TRP or TRP #0.
(8) Step 318: UE 301 transmits the RRC reconfiguration complete message to target BS 303 when UE 301 completes the RA in the specific TRP, e.g., the primary TRP or TRP #0.
   1) Regarding when to perform a RA to another TRP (e.g., TRP #1) among the configured TRPs after stopping timer T304, there may be following two options in different embodiments, i.e., Option 1 and Option 2.
      Option 1: UE 301 can perform a RA to TRP #1 after successfully completing the RA to the primary TRP or TRP #0.
      Option 2: UE 301 does not perform a RA to TRP #1 after successfully completing the RA to the primary TRP or TRP #0, but performs the RA to TRP #1 based on a UL data arrival associated with TRP #1 or a request from source BS 302.
(9) Step 319: Target BS 303 receives the RRC reconfiguration complete message and performs a path switch operation for a link between target BS 303 and a core network.
(10) Step 320: After completing the path switch operation for the link between target BS 303 and the core network, target BS 303 sends a UE context release message to inform source BS 302 about the success of the handover. Source BS 302 can then release radio and C-plane related resources associated with the context of UE 301.

In Embodiment #2, exemplary procedure 300 includes following steps.
(1) Details of Step 311 to Step 316 in Embodiment #2 are the same as those of Step 311 to Step 316 in Embodiment #1, respectively.
   1) In an embodiment, in Step 316, UE 301 receives an RRC reconfiguration message including a reconfigurationwithsync IE.
   2) In an embodiment, multiple TRPs (e.g., two TRPs) having different TA may be configured to a target PCell.
(2) Step 317: UE 301 starts timer T304 and performs a RA to a TRP among the configured multiple TRPs (e.g., two TRPs).
   1) In an embodiment, UE 301 stops T304 when UE 301 completes a RA in any one TRP within multiple TRPs.
(3) Step 318: UE 301 transmits an RRC reconfiguration complete message to target BS 303 when UE 301 completes the RA in any one TRP within multiple TRPs.
   2) Two cases may happen in different embodiments, i.e., Case 2A and Case 2B 2.
      Case 2A: UE 301 successfully completes the RA to one TRP (e.g., TRP #1) among the configured TRPs for one cell after executing the RRC reconfiguration.
      In Case 2A, regarding when to perform a RA to a further TRP (e.g., TRP #2) among the configured TRPs after stopping timer T304, there may be following two options in different embodiments, i.e., Option 1 and Option 2.
         a) Option 1: UE 301 can perform a RA to TRP #2 after successfully completing the RA to TRP #1.
         b) Option 2: UE 301 does not perform the RA to TRP #2 after successfully completing the RA to TRP #1, but performs the RA to TRP #2 based on the UL data arrival associated with TRP #2 or a request from source BS 302.
      Case 2B: UE 301 fails to complete a RA to TRP #1 (e.g., a RA failure occurs during the RA to TRP #1) after executing RRC reconfiguration including the reconfigurationwithsync IE, but UE 301 successfully complete the RA to TRP #2 after the RA failure occurs during the RA to TRP #1.
         a) For instance, when reaching a maximum number of preamble transmissions per TRP (e.g., TRP #1), UE 301 is allowed to change to perform a RA to another TRP (e.g., TRP #2).
         b) In Case 2B, if the RA to one TRP among the configured TRPs failed, UE 301 may report failure information, e.g., ID of the failed TRP (e.g., TRP #1), to network. For instance, the failure information can be reported via an RRC reconfiguration complete message, e.g., if a RA failure occurs during the RA to TRP #1.
(4) Step 319: Target BS 303 receives the RRC reconfiguration complete message and performs a path switch operation for a link between target BS 303 and a core network.
(5) Step 320: After completing the path switch operation for the link between target BS 303 and the core network, target BS 303 sends a UE context release message to inform source BS 302 about the success of the handover. Source BS 302 can then release radio and C-plane related resources associated to the context of UE 301.

In Embodiment #3, exemplary procedure 300 includes following steps.
(1) Details of Step 311 to Step 316 in Embodiment #3 are the same as those of Step 311 to Step 316 in Embodiment #1, respectively.
   1) In an embodiment, in Step 316, UE 301 receives an RRC reconfiguration message including a reconfigurationwithsync IE.
   2) In an embodiment, multiple TRPs (e.g., two TRPs) having different TA may be configured to a target PCell.
(2) Step 317: UE 301 starts timer T304 and performs a RA to all configured TRPs in the target PCell, e.g., two TRPs.
   1) In an embodiment, UE 301 stops T304 when UE 301 completes the RA in all configured TRPs (e.g., two TRPs) of the target PCell.
(3) Step 318: when UE 301 completes the RA in all configured TRPs (e.g., two TRPs), UE 301 transmits an RRC reconfiguration complete message to target BS 303 in any one TRP.
(4) Step 319: Target BS 303 receives the RRC reconfiguration complete message and performs a path switch operation for the link between target BS 303 and a core network.
(5) Step 320: After completing the path switch operation for the link between target BS 303 and the core network, target BS 303 sends a UE context release message to inform source BS 302 about the success of the handover. Source BS 302 can then release radio and C-plane related resources associated to the context of UE 301.

FIG. 4 illustrates a further exemplary flowchart of a PCell change procedure according to some embodiments of the present application. Details described in all other embodiments of the present disclosure are applicable for the embodiments shown in FIG. 4. Referring to FIG. 4, UE 401 may function as UE1 as shown in FIG. 1. In particular, exemplary procedure 400 includes following steps.
(1) Details of Step 411 to Step 416 in exemplary procedure 400 are the same as those of Step 311 to Step 316 in Embodiment #1, respectively.
(2) Step 417: UE 401 starts T304 and performs a RA to all configured TRPs in the target PCell, e.g., two TRPs.
(3) Step 418: If T304 expires before UE 401 completes the RA to any TRP among the configured TRPs, UE 401 performs an RRC re-establishment procedure to BS 404.
(4) Step 419: After successfully completing the RRC re-establishment procedure to a cell of BS 404, UE 401 reports the assistance information to the re-established cell of BS 404.
   1) In an embodiment, the assistance information is included in a RLF report and/or an RRC re-establishment request message.
   2) In an embodiment, once a handover failure occurs before the expiry of T304, the RLF report and/or the RRC re-establishment request message could include information as follow:
      An ID of a TRP (e.g., a CORESET ID, a panel ID, and/or a beam set ID) to which the RA is successfully completed.
      An ID of a TRP to which the RA is failed.

FIG. 5 illustrates an exemplary flowchart of a SCG addition procedure according to some embodiments of the present application. Details described in all other embodiments of the present disclosure are applicable for the embodiments shown in FIG. 5. Exemplary procedure 500 refers to a scenario of multiple TRPs with different TA configured in one cell during a SCG addition procedure in which a MR-DC operation is configured. In some cases, a SCG addition procedure may also be named as a PSCell addition procedure or a SN addition procedure.

Referring to FIG. 5, UE 501 may function as UE1 as shown in FIG. 1. In particular, exemplary procedure 500 includes following steps.
(1) In Step 511, MN 502 (which may also be named as source BS 502) transmits an RRC reconfiguration message including measurement configuration(s) to UE 501, and UE 501 transmits a measurement report according to the measurement configuration(s).
   1) In some embodiments, UE 501 reports the capability information to MN 502, e.g., whether UE 501 supports multiple TRPs with different TA or not.
(2) Step 512: MN 502 decides to add a secondary cell group (SCG) to UE 501 based on the measurement report from UE 501.
(3) Step 513: MN 502 transmits a SN addition request message to target SN 503.
(4) Step 514: Target SN 503 performs an admission control based on the load and the service supported by target SN 503.
(5) Step 515: Target SN 503 sends a SN addition request acknowledge message to MN 502, which includes a transparent container to be sent to UE 501 as an RRC message to perform a SN addition operation.
(6) Step 516: After receiving the SN addition request acknowledge message, MN 502 sends an RRC reconfiguration message to UE 501.
   1) In an embodiment, UE 501 receives the RRC reconfiguration message including a reconfigurationwithsync IE associated with the SN addition operation.
   2) In an embodiment, multiple TRPs (e.g., two TRPs) having different TA may be configured to a target PSCell.
(7) Steps 517 and 518: UE 501 starts timer T304 in Step 517. There may be following three potential ways in different embodiments.
   1) An potential way: If multiple TRPs (e.g., two TRPs) having different TA are configured to the target PSCell, target SN 503 further configures to which TRP UE 501 can perform a RA during mobility.
      In one embodiment, it may be defined in 3GPP specification that UE 501 needs to perform a RA on a specific TRP, e.g., the primary TRP or TRP #0. TRP #0 may be a TRP with the first entry in a TRP list configured in the RRC reconfiguration message. TRP #0 may be named as “first TRP” or the like.
      In one embodiment, UE 501 may stop timer T304 when UE 501 completes the RA to the specific TRP, e.g., the primary or TRP #0.
      In one embodiment, when UE 501 completes the RA in the specific TRP, e.g., the primary TRP or TRP #0, UE 501 transmits an RRC reconfiguration complete message to MN 502 in Step 518.
   2) A further potential way: If multiple TRPs (e.g., two TRPs) having different TA are configured to the target PSCell, UE 501 considers that the mobility is successfully completed once UE 501 completes the RA for UL synchronization in any one among the configured TRPs (e.g., two TRPs).
      In one embodiment, once UE 501 completes the RA for UL synchronization in any one among the configured TRPs, UE 501 stops T304 and transmits an RRC reconfiguration complete message to MN 502 in Step 518.
   3) Another potential way: If multiple TRPs (e.g., two TRPs) having different TA are configured in a handover command, UE 501 considers that the handover is successfully completed once UE 501 completes the RA for UL synchronization in all configured TRPs (e.g., two TRPs).
      In one embodiment, once UE 501 completes the RA for UL synchronization in all configured TRPs (e.g., two TRPs), UE 501 stops timer T304 and transmits an RRC reconfiguration complete message in any one TRP among the configured TRPs to MN 502 in Step 518.
(8) Step 519: MN 502 transmits the reconfiguration complete message to target SN 503.

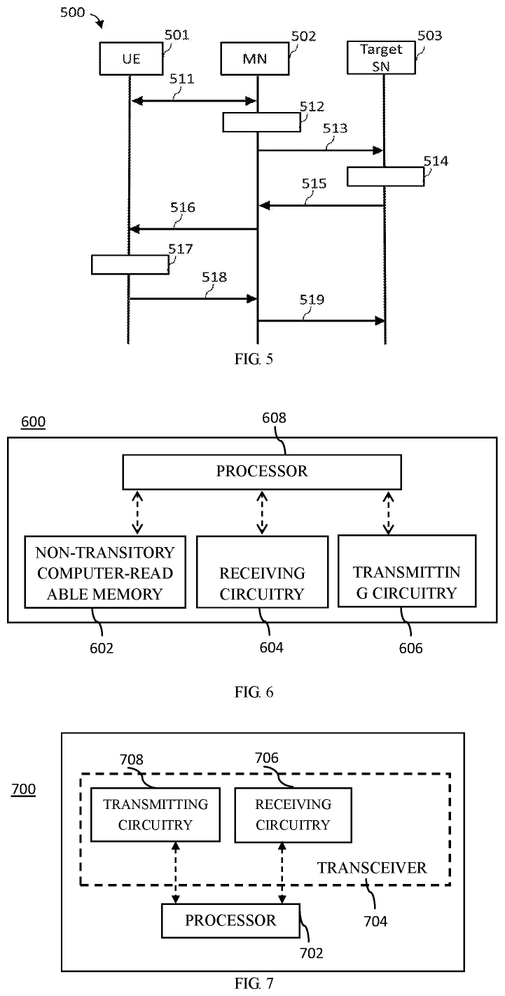

FIG. 6 illustrates an exemplary block diagram of an apparatus 600 for a case of multiple TRPs with multiple TA according to some embodiments of the present application.

As shown in FIG. 6, the apparatus 600 may include at least one non-transitory computer-readable medium 602, at least one receiving circuitry 604, at least one transmitting circuitry 606, and at least one processor 608 coupled to the non-transitory computer-readable medium 602, the receiving circuitry 604 and the transmitting circuitry 606. The at least one processor 608 may be a CPU, a DSP, a microprocessor etc. The apparatus 600 may be a UE or a network apparatus (e.g., a BS) configured to perform a method illustrated in the above or the like.

Although in this figure, elements such as the at least one processor 608, receiving circuitry 604, and transmitting circuitry 606 are described in the singular, the plural is contemplated unless a limitation to the singular is explicitly stated. In some embodiments of the present application, the receiving circuitry 604 and the transmitting circuitry 606 can be combined into a single device, such as a transceiver. In certain embodiments of the present application, the apparatus 600 may further include an input device, a memory, and/or other components.

In some embodiments of the present application, the non-transitory computer-readable medium 602 may have stored thereon computer-executable instructions to cause a processor to implement the methods with respect to a UE or a network apparatus (e.g., a BS) as described or illustrated above in any of FIGS. 2-5. For example, the computer-executable instructions, when executed, cause the processor 608 interacting with receiving circuitry 604 and transmitting circuitry 606, so as to perform the steps with respect to a UE or a network apparatus (e.g., a BS) as described or illustrated above in any of FIGS. 2-5.

FIG. 7 illustrates a further exemplary block diagram of an apparatus 700 for a case of multiple TRPs with multiple TA according to some embodiments of the present application.

Referring to FIG. 7, the apparatus 700, for example a BS or a UE, may include at least one processor 702 and at least one transceiver 704 coupled to the at least one processor 702. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some other embodiments of the present application, when the apparatus 700 is a UE, the processor 702 may be configured: to receive a radio resource control (RRC) reconfiguration message for mobility associated with a target cell via the transceiver 704 from a network, wherein the RRC reconfiguration message for mobility includes a configuration regarding two transmission reception points (TRPs) of the target cell, and wherein the two TRPs have two different timing advance (TA), respectively; and in response to receiving the RRC reconfiguration message for mobility, to perform a random access (RA) procedure to the target cell and to start a mobility timer.

According to some embodiments of the present application, when the apparatus 700 is a network node (e.g., a BS), the processor 702 is configured to transmit a radio resource control (RRC) reconfiguration message for mobility associated with a target cell via the transceiver 704 to a user equipment (UE), wherein the RRC reconfiguration message for mobility includes a configuration regarding two transmission reception points (TRPs) of the target cell, and wherein the two TRPs have two different timing advance (TA), respectively.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a radio resource control (RRC) reconfiguration message for mobility associated with a target cell from a network, wherein the RRC reconfiguration message for mobility includes a configuration regarding two transmission reception points (TRPs) of the target cell, and wherein the two TRPs have two different timing advance (TA), respectively; and
response to receiving the RRC reconfiguration message for mobility, to perform a random access (RA) procedure to the target cell and to start a mobility timer.

2. The UE of claim 1, wherein the target cell is a primary cell of a master cell group (PCell) or a primary cell of a second cell group (PSCell).

3. The UE of claim 1, wherein the configuration indicates that the two TRPs belong to different timing advance groups (TAGs).

4. The UE of claim 1, wherein the configuration includes first identity (ID) information of each TRP within the two TRPs.

5. The UE of claim 1, wherein the RRC reconfiguration message for mobility indicates a first TRP or a primary TRP to which the UE can perform the RA procedure within the two TRPs.

6. The UE of claim 5, wherein, to perform the RA procedure to the target cell, the at least one processor of the UE is configured to cause the UE to perform the RA procedure to the first TRP or the primary TRP.

7. The UE of claim 6, wherein the at least one processor is configured to cause the UE to:
stop the mobility timer upon a successful completion of the RA procedure to the first TRP or the primary TRP; and
transmit an RRC reconfiguration complete message to the target cell.

8. The UE of claim 1, wherein the at least one processor is configured to cause the UE to:
stop the mobility timer upon a successful completion of the RA procedure to one TRP within the two TRPs; and
transmit an RRC reconfiguration complete message to the target cell.

9. The UE of claim 8, wherein, in response to failing to complete the RA procedure to one TRP within the two TRPs, the at least one processor of the UE is configured to cause the UE to transmit failure information regarding the one TRP to the network.

10. The UE of claim 9, wherein the failure information is transmitted via an RRC reconfiguration complete message or other RRC message.

11. The UE of claim 9, wherein the failure information includes at least one of: second ID information of the one TRP in which a RA failure happens, or a failure cause.

12. The UE of claim 11, wherein the failure cause includes at least one of: reaching a maximum number of preamble transmission of the one TRP; or an occurrence of the RA failure.

13. The UE of claim 8, wherein the at least one processor is configured to cause the UE to perform the RA procedure to a second TRP within the two TRPs upon:
the successful completion of the RA procedure to the other TRP within the two TRPs;
an uplink (UL) data arrival associated with the second TRP; or
a reception of a message for requesting the UE to perform the RA procedure to the second TRP from the network.

14. The UE of claim 1, wherein the at least one processor is configured to cause the UE to:
stop the mobility timer upon a successful completion of the RA procedure to all of the two TRPs; and
transmit an RRC reconfiguration complete message to the target cell.

15. A network node, comprising:
at least one memory; and
at least one processor coupled with the at least one memory and configured to cause the network node to:
transmit a radio resource control (RRC) reconfiguration message for mobility associated with a target cell to a user equipment (UE), wherein the RRC reconfiguration message for mobility includes a configuration regarding two transmission reception points (TRPs) of the target cell, and wherein the two TRPs have two different timing advance (TA), respectively.

16. The network node of claim 15, wherein the target cell is a primary cell of a master cell group (PCell) or a primary cell of a second cell group (PSCell).

17. The network node of claim 15, wherein the configuration indicates that the two TRPs are belonging to different timing advance groups (TAGs).

18. The network node of claim 15, wherein the configuration includes first identity (ID) information of each TRP within the two TRPs.

19. The network node of claim 15, wherein the RRC reconfiguration message for mobility indicates a first TRP or a primary TRP to which the UE can perform an RA procedure within the two TRPs.

20. A method performed by a network node, the method comprising:
transmitting a radio resource control (RRC) reconfiguration message for mobility associated with a target cell to a user equipment (UE), wherein the RRC reconfiguration message for mobility includes a configuration regarding two transmission reception points (TRPs) of the target cell, and wherein the two TRPs have two different timing advance (TA), respectively.
